(19) United States
(12) Patent Application Publication
(10) Pub. No.: US 2015/0269798 A1
(43) Pub. Date: Sep. 24, 2015

(54) SYSTEM AND METHOD FOR SELECTIVE ACCESS TO AN ANIMAL FOOD CONTAINER UTILIZING AN EMBEDDED RFID MICROCHIP

(71) Applicant: Austin Small, Lower Gwynedd, PA (US)

(72) Inventor: Austin Small, Lower Gwynedd, PA (US)

(21) Appl. No.: 14/680,157

(22) Filed: Apr. 7, 2015

Related U.S. Application Data
(60) Provisional application No. 61/976,083, filed on Apr. 7, 2014.

(51) Int. Cl. G07C 9/00; A01K 5/02

(52) U.S. Cl. CPC G07C 9/00111; A01K 5/02

(57) ABSTRACT

A system for providing selective access to a food cavity including a base defining the food cavity. A cover is connected to the base and moveable between a closed condition wherein the cover prevents access to the food cavity and an open condition wherein access to the food cavity is available. A ring antenna is supported relative to the base such that it extends generally perpendicular to a base surface of the base and is positioned forward of the food cavity. The ring antenna defines a circumferential ring with an opening therethrough and contains an RFID coil over at least a portion thereof about the opening. A motor is configured to move the cover from the closed condition to the open condition upon sensing of a registered RFID identification proximate to the ring antenna.

This application claims the benefit of U.S. Provisional Application No. 61/976,083 filed on Apr. 7, 2014, the contents of which are incorporated herein by reference.

### FIELD OF THE INVENTION

This invention relates to a pet food container. More specifically, the present invention relates to a pet food container configured to provide selective access based on a sensed operation signal.

### BACKGROUND OF THE INVENTION

In a multi-pet house household, it is quite common to have pets that need medicine, special diets, or differing quantities of food relative to other pets in the home. Unfortunately, due to the social order of pets, a dominant animal may consume the food or medicine intended for a sick, elderly, or subordinate pet in the household.

Lindsay (U.S. Pat. No. 7,395,782) discloses a device that addresses this issue by regulating access to a food container through the use of a radio-frequency identification (“RFID”) tag worn on a pet's collar. However, Lindsay's device is unable to read embedded RFID capsules, which are located under the skin, at the back of the neck, and between the shoulder blades of the pet, due to the relatively short read distance of pet RFID tags (approximately 4 inches or 10 centimeters) as well as the difficulty of reading a pet RFID capsule through an animal's body. This is a significant inconvenience, since the use of RFID capsules, which are now the preferred method by veterinarians of lost pet identification, is becoming quite prevalent with domestic animals. In addition, many animals do not tolerate pet collars.

An alternative design disclosed in Moffett-Chaney (U.S. Pat. No. 8,286,591 B2) uses a cat door attached to a large enclosure. This device can read an embedded RFID capsule, but it requires the pet to completely enter an enclosure in order to gain access to a food bowl, bedding, a litter pan, or whatever is within the enclosure. This is not practical for daily feeding purposes and many pets will not enter such an enclosure for fear of becoming trapped.

### SUMMARY OF THE INVENTION

In at least one embodiment, the present invention provides a system including a food container that allows for selective access to its contents through the use of an embedded RFID microchip capsule, which is about the size of a large grain of rice, and which is typically implanted under the skin of the animal, along the back of the neck, and between the shoulder blades.

In at least one embodiment, the invention provides a system for providing selective access to a food cavity including a base defining the food cavity. A cover is connected to the base and moveable between a closed condition wherein the cover prevents access to the food cavity and an open condition wherein access to the food cavity is available. A ring antenna is supported relative to the base such that it extends generally perpendicular to a base surface of the base and is positioned forward of the food cavity. The ring antenna defines a circumferential ring with an opening therethrough and contains an RFID coil over at least a portion thereof about the opening. A motor is configured to move the cover from the closed condition to the open condition upon sensing of a registered RFID identification proximate to the ring antenna.

In at least one embodiment, the RFID coil transmits RFID signals to an RFID reader positioned within the base. The system may further include a microprocessor within the base configured to receive signals from the RFID reader and actuate the motor upon receipt of a signal corresponding to the registered RFID identification.

In another aspect, the invention provides a method of providing selective access to a food cavity of a food access system, the food access system including a base defining the food cavity, a cover connected to the base and moveable between a closed condition wherein the cover prevents access to the food cavity and an open condition wherein access to the food cavity is available, a ring antenna defining a circumferential ring with an opening therethrough, the ring antenna containing an RFID coil over at least a portion thereof about the opening, the ring antenna supported relative to the base such that it extends generally perpendicular to a base surface of the base and is positioned forward of the food cavity; a microprocessor and a motor configured to move the cover from the closed condition to the open condition, the method comprising the steps of: registering in the microcontroller an RFID identification corresponding to an RFID microchip embedded within a neck area of a desired pet; sensing for RFID signals proximate to the ring antenna; comparing any sensed RFID signals to the registered RFID identification; and operating the motor to move the cover to the open condition upon matching of a sensed RFID signal with the registered RFID identification.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view of an exemplary system in accordance with the invention in the closed condition when an animal's embedded RFID capsule is not within reading range of the antenna.

FIG. 2 is a perspective view similar to FIG. 1 with the system in an open condition as the approaching animal's embedded RFID capsule is read and identified by the encircling antenna.

FIG. 3 is an exploded perspective view of the system of FIG. 1.

FIG. 4 is a perspective view of an exemplary food container insert used to hold the food, water, or medicine in the system.

FIG. 5 is a front elevation view of the system of FIG. 1.

FIG. 6 is a side elevation view of the system of FIG. 1.

FIG. 7 is an exploded perspective view of the antenna components.

FIG. 8 is a rear elevation view of the system of FIG. 1.

FIG. 9 is a top plan view of the system of FIG. 1.

FIG. 10 is a bottom plan view of the system of FIG. 1, which illustrates mounting surfaces for the processor, RFID reader, and motor.

FIG. 11 illustrates the invention's electrical circuits and motor, which are embedded within its base.

### DETAILED DESCRIPTION OF THE INVENTION

In the drawings, like numerals indicate like elements throughout. Certain terminology is used herein for convenience only and is not to be taken as a limitation on the present invention. The following describes preferred embodiments of the present invention. However, it should be understood, based on this disclosure, that the invention is not limited by the preferred embodiments described herein.

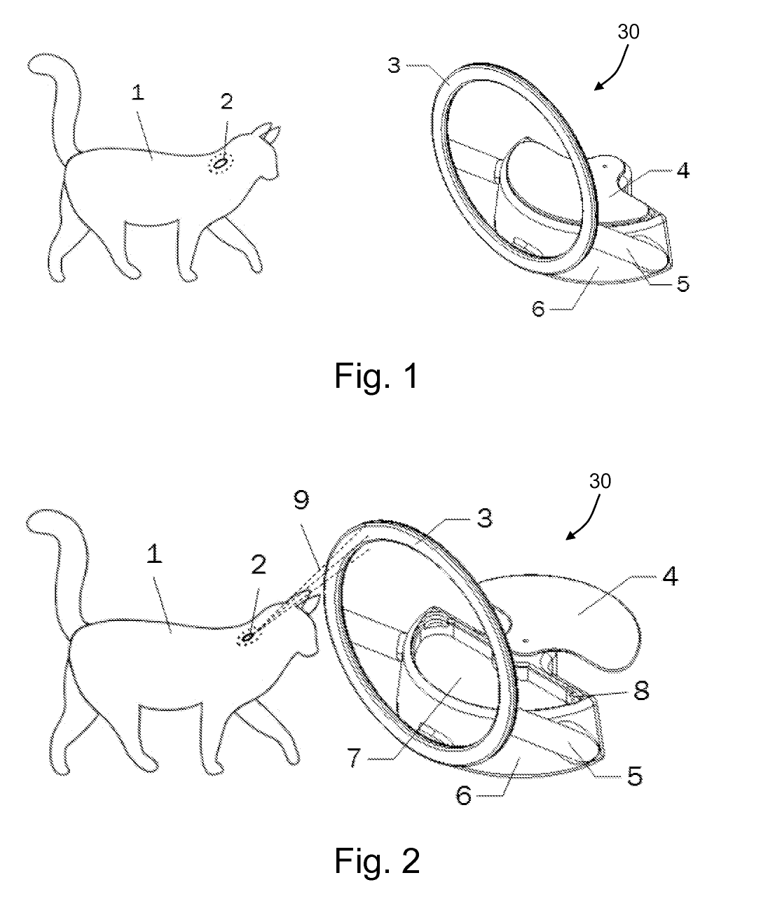

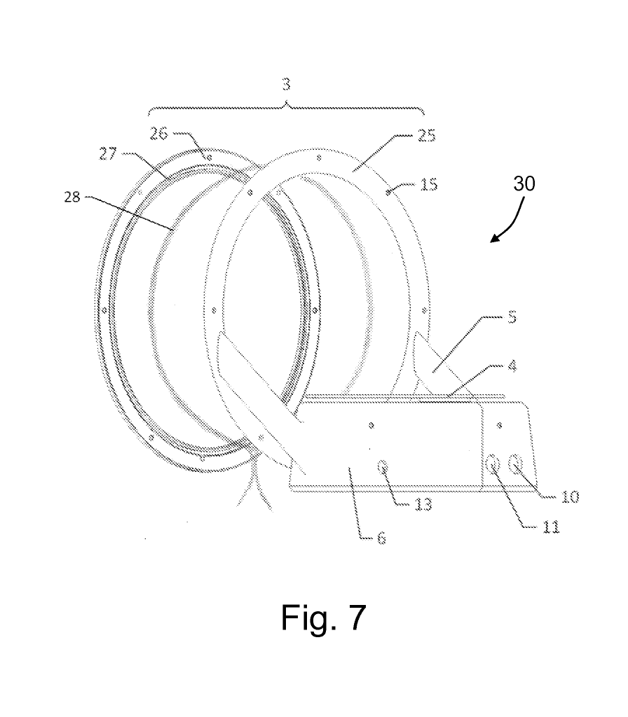

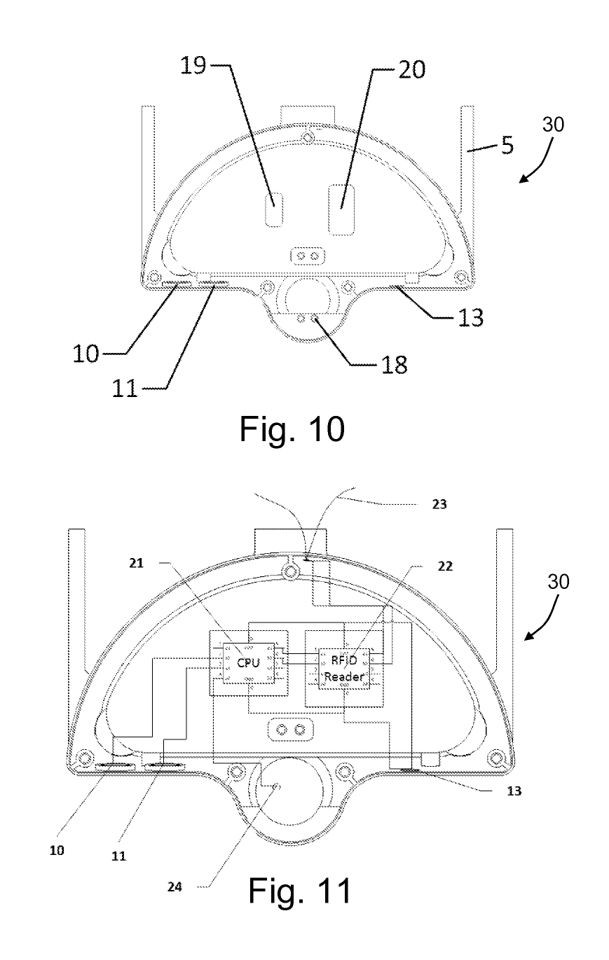

A system 30 in accordance with an exemplary embodiment of the present invention is illustrated in FIGS. 1-11. Referring to FIGS. 1 and 2, the system 30 generally comprises a base 6 and a ring antenna 3. A food cavity 7 is defined within the base 6, preferably positioned rearwardly of the ring antenna 3 such that when a pet 1 extends their head through the ring antenna 3, the pet's neck will be adjacent the antenna 3 and their mouth will be able to eat from the food cavity 7. A cover 4 is rotatably connected to the base 6 such that it is moveable between a closed condition illustrated in FIG. 1 and an open condition illustrated in FIG. 2. In the closed condition, the cover 4 encloses the food cavity 7 such that a pet or other animal cannot access the contents of the food cavity 7 unless they have an appropriate signal, as discussed in more detail hereinafter.

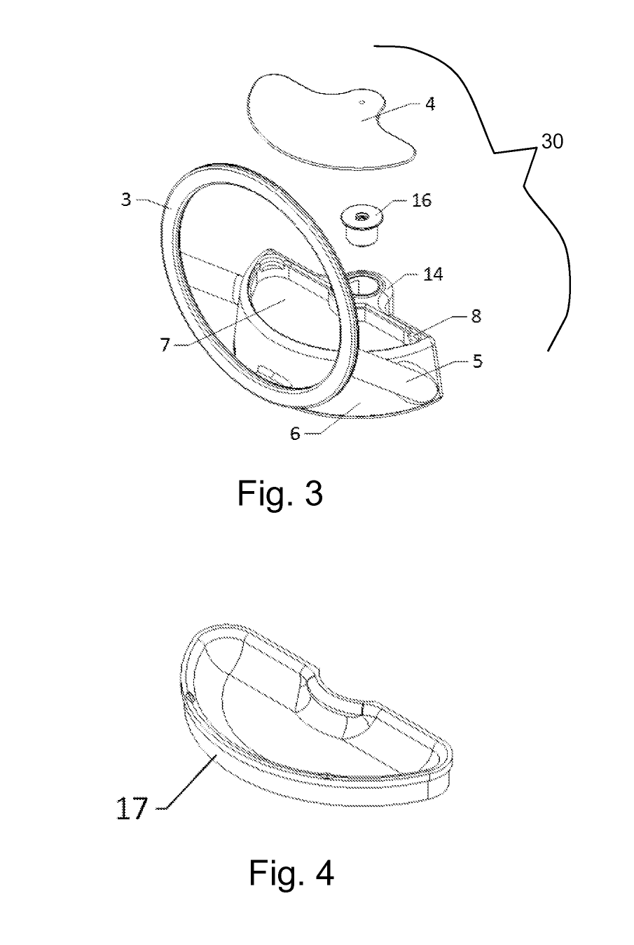

Referring to FIG. 3, the base 6 defines a shaft housing 14 configured to receive a shaft 16 which connects the cover 4 to the electric motor inside the device's body. As illustrated in FIG. 9, a knurled thumb screw 12 or the like holds the cover 4 to the shaft 16. Operation of the motor, as described hereinafter, rotates the cover 4 between the closed condition and the open condition. While a rotatable cover is described herein, it is recognize that the cover 4 may otherwise move between the closed and open conditions, for example, the cover could be configured to pivot away from the antenna ring to the open condition.

In the open condition, food, medicine, water or the like within the food cavity 7 is accessible. While it is possible to place the items directly within the cavity 7, it is preferable to position the items within a food container insert 17 which is then positioned within the cavity 7. An exemplary food container insert 17 is illustrated in FIG. 4 and has a configuration which complements the configuration of the food cavity 7. Such a food container insert 17 can be easily removed by using the finger slots 8 in the food cavity for easy extraction of the food container 17. The exemplary food container 17 is for illustrative purposes and it will be understood that various containers may be utilized within the cavity 7.

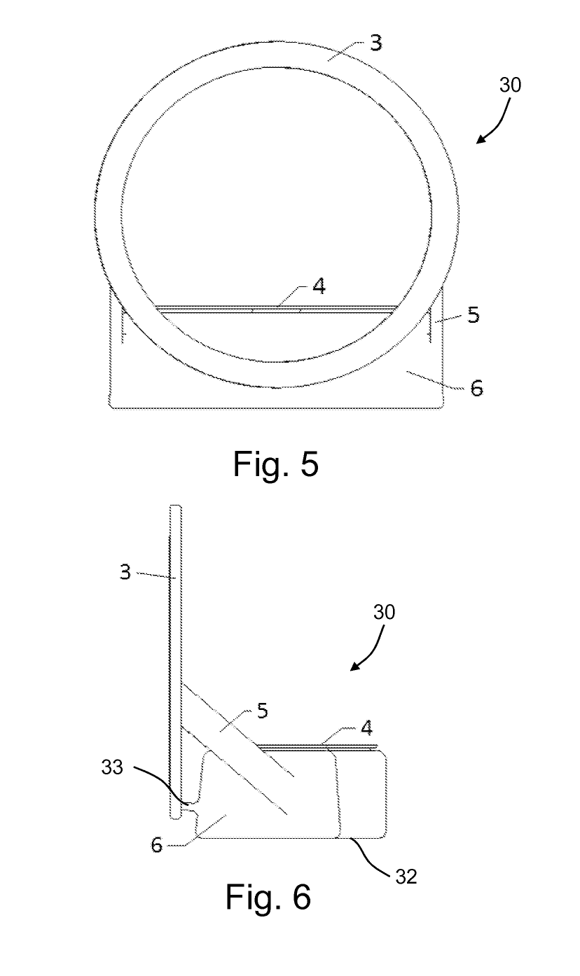

Referring to FIGS. 5-7, an exemplary ring antenna 3 will be described. In the illustrated embodiment, the ring antenna 3 is connected to the base 6 by two support arms 5 and a lower mounting bracket 33. The ring antenna 3 preferably extends in a plane which is substantially perpendicular to a support surface 32 of the base 6 such that it is easy for a pet to extend their head through the open ring. It is contemplated that the ring antenna 3 may be positioned such that it is tilted slightly forward or slightly rearward.

The exemplary ring antenna 3 includes a back plate 25 which is connected to the arms 5 and a complementary front plate 26. The front plate 26 has a groove 27 defined therein configured to receive an RFID coil 28. With the RFID coil 28 positioned within the groove 27, the plates 25 and 26 are connected together by threaded mounts 15, or the like. The ring antenna 3 preferably takes the form of a halo antenna, but may be otherwise configured. The lower mounting bracket 33 preferably extends between the base 6 and the back plate 25 such that antenna leads 23 may extend from the RFID coil 28 to the controller within the base 6, as will be described hereinafter.

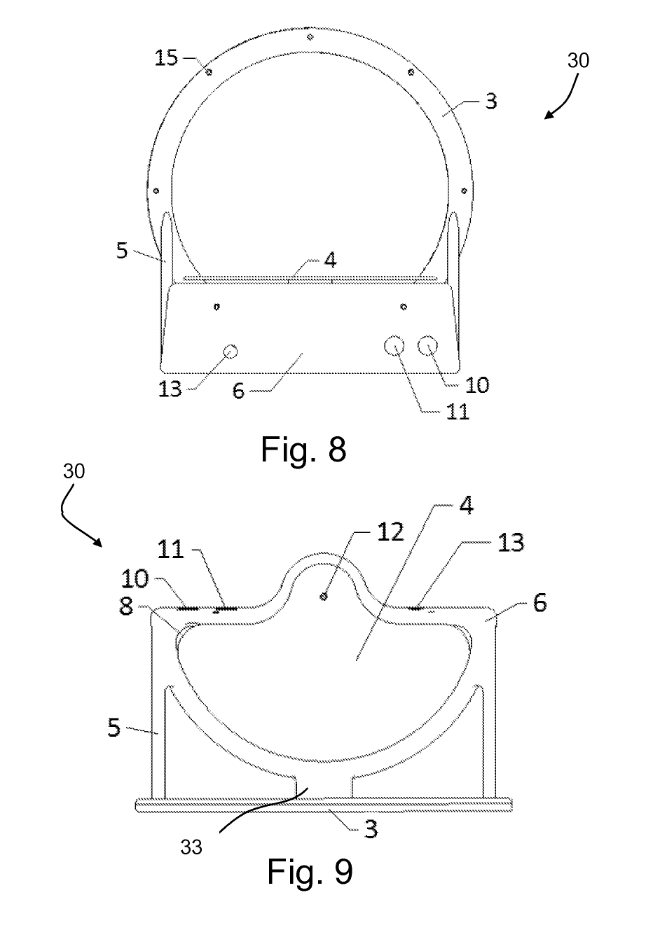

Referring to FIGS. 8-11, the exemplary system 30 is powered by a DC input 13, however, it is understood that other power sources, for example battery or solar power, may be utilized. The base 6 includes mounts 18, 19 and 20 for the electric motor 24, microprocessor 21 and RFID reader 22, respectively. DC power is supplied to both the processor 21 and the RFID reader 22 from the DC input 13. The RFID reader 22 is connected to the antenna leads 23, which in turn are connected to the RFID coil 28.

The electric motor 24 is driven by the microprocessor 21. The microprocessor receives signals received from the RFID reader 22, an operator button 10 and a training button 11. The operator button 10 may be used to open and close the lid when the user wishes to access the food cavity and food container.

The training button 11 is utilized to store a selected RFID ID in the microprocessor which is indicative of a pet permitted to access the food cavity 7. In an exemplary mode of operation, when the training button 11 is pressed, the microprocessor 21 enters a learning mode and the cover 4 is moved to the open condition. To indicate that the system is in training mode, the button 11 itself or another indicator light may be configured to blink. When in training mode, the pet's favorite food is placed into the food container insert 17, which is placed into the food cavity 7 of the device. The pet 1 will naturally accesses the food by placing its head through the ring antenna 3. The pet's microchip identity is sensed by the RFID reader and provided to the microprocessor 21 such that it can be registered. Upon registration, the training LED ceases blinking to indicate that the pet's RFID microchip has been registered. Once the pet extracts its head away from the antenna, the lid is rotated to the closed condition. Thereafter, when the registered ID is sensed, the microprocessor 21 actuates the motor 24 to move the cover 24 to the open condition. The system 30 is ready for use.

Referring again to FIGS. 1 and 2, as a pet 1 approaches with an embedded RFID microchip capsule 2, the ring antenna 3 energizes circuitry inside the pet's RFID capsule, causing the capsule to emit an RFID identity 9 which is detected by the ring antenna 3. If the pet's RFID identity 9 matches the registered ID in the microprocessor 21, then the cover 4 is rotated to the open position as depicted in FIG. 2, allowing the pet to access the device's contents. The system 30 is preferably configured such that the cover 4 will remain in the open position until the RFID tag is removed from its proximity to the ring antenna 3.

The system and method described herein provide selective access to an animal food container, which utilize an RFID microchip capsule embedded within a domestic pet. Through the use of an embedded RFID capsule, this invention makes use of technology currently recommended by veterinarians for the purpose of lost pet identification. In addition, the pet does not need to wear a collar, which many animals do not tolerate. Finally, by not requiring entrance into an enclosure, this invention allows the pet to maintain complete awareness of its surroundings at all times.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

What is claimed is:

1. A system for providing selective access to a food cavity, the system comprising:
a base defining the food cavity,
a cover connected to the base and moveable between a closed condition wherein the cover prevents access to the food cavity and an open condition wherein access to the food cavity is available,
a ring antenna defining a circumferential ring with an opening therethrough, the ring antenna containing an RFID coil over at least a portion thereof about the opening, the ring antenna supported relative to the base such that it extends generally perpendicular to a base surface of the base and is positioned forward of the food cavity; and
a motor configured to move the cover from the closed condition to the open condition upon sensing of a registered RFID identification proximate to the ring antenna.

2. The system of claim 1 wherein the RFID coil transmits RFID signals to an RFID reader positioned within the base.

3. The system of claim 2 further comprising a microprocessor within the base configured to receive signals from the RFID reader and actuate the motor upon receipt of a signal corresponding to the registered RFID identification.

4. The system of claim 3 further comprising an operator button associated with the microprocessor and configured such that the microprocessor will actuate the motor upon receipt of a signal corresponding to actuation of the operator button.

5. The system of claim 3 further comprising a training button associated with the microprocessor and configured such that the microprocessor will enter a training mode and actuate the motor upon receipt of a signal corresponding to actuation of the training button.

6. The system of claim 5 wherein in training mode, the microprocessor is configured to register the next sensed RFID identification as the registered RFID identification.

7. The system of claim 6 wherein the microprocessor is configured to exit the training mode once the RFID identification is sensed and registered.

8. The system of claim 3 wherein the motor, the RFID reader and the microcontroller are powered by a power source.

9. The system of claim 8 wherein the power source is selected from one of DC power, battery power and solar power.

10. The system of claim 1 wherein the motor is configured to rotate the cover between the closed and open conditions.

11. The system of claim 1 wherein the cover remains in the open condition so long as the registered RFID identification is sensed as proximate to the ring antenna.

12. The system of claim 11 wherein the cover automatically returns to the closed position once the registered RFID identification is no longer sensed as proximate to the ring antenna.

13. The system of claim 1 wherein the RFID coil extends about the entire circumference of the circumferential ring.

14. The system of claim 1 wherein the ring antenna extends tilted slightly forward or slightly rearward relative to the base surface.

15. The system of claim 1 further comprising a container insert configured to be positioned within the food cavity.

16. A method of providing selective access to a food cavity of a food access system, the food access system including a base defining the food cavity, a cover connected to the base and moveable between a closed condition wherein the cover prevents access to the food cavity and an open condition wherein access to the food cavity is available, a ring antenna defining a circumferential ring with an opening therethrough, the ring antenna containing an RFID coil over at least a portion thereof about the opening, the ring antenna supported relative to the base such that it extends generally perpendicular to a base surface of the base and is positioned forward of the food cavity; a microprocessor; and a motor configured to move the cover from the closed condition to the open condition, the method comprising the steps of:
registering in the microcontroller an RFID identification corresponding to an RFID microchip embedded within a neck area of a desired pet;
sensing for RFID signals proximate to the ring antenna;
comparing any sensed RFID signals to the registered RFID identification; and
operating the motor to move the cover to the open condition upon matching of a sensed RFID signal with the registered RFID identification.

17. The method of claim 16 wherein the registering step includes:
placing the microprocessor in a training mode upon receipt of a signal corresponding to actuation of a training button; and
registering the next sensed RFID identification as the registered RFID identification.

18. The method of claim 17 further comprising exiting the training mode once the RFID identification is sensed and registered.

19. The method of claim 16 further comprising actuating the motor upon receipt of a signal corresponding to actuation of an operator button.

20. The method of claim 16 further comprising automatically returning the cover to the closed position once the registered RFID identification is no longer sensed as proximate to the ring antenna.
